(19) United States
(12) Patent Application Publication
(10) Pub. No.: US 2026/0322746 A1
(43) Pub. Date: Oct. 15, 2026

(54) COORDINATION FOR ROUND-TRIP COMMUNICATIONS

(71) Applicant: Nokia Solutions and Networks Oy, Espoo (FI)

(72) Inventors: Hua CHAO, Shanghai (CN); Yong Gang WANG, Shanghai (CN); Alistair URIE, Massy (FR)

(21) Appl. No.: 19/484,455

(22) PCT Filed: May 19, 2023
(86) PCT No.: PCT/CN2023/095284

§ 371 Date: Nov. 14, 2025

(51) Int. Cl. H04L 47/24; H04W 72/1263

(52) U.S. Cl. CPC H04L 47/24; H04W 72/1263

(57) ABSTRACT

Embodiments of the present disclosure relate to devices, methods, apparatuses and computer readable storage media of coordination for round-trip communications. The method comprises receiving, from a RAN device, an event associated with at least one quality of service, QoS, flow of a specific traffic type, wherein the at least one QoS flow is associated with a flow coordination group identity; and performing a coordination for the at least one QoS flow based at least on the event.

### FIELD

Embodiments of the present disclosure generally relate to the field of telecommunication and in particular to devices, methods, apparatuses and computer readable storage media of coordination for round-trip (RT) communications.

### BACKGROUND

In 5G era, mobile media services, Augmented Reality (AR)/Virtual Reality (VR)/extended Reality (XR), cloud gaming, video-based tele-control for machines or drones, are expected to contribute more and more traffics to 5th Generation Mobile Communication Technology (5G) network. All media traffics, despite which codec was used, have some common characteristics, e.g., high throughput, low latency, and high reliability requirement. To support these common characteristics, AR/VR/XR and interactive media services, called as XR media (XRM) services in short, can reuse the current 5G System (5GS) generic Time Sensitive Communications (TSC) and exposure framework.

### SUMMARY

In a first aspect, there is provided an apparatus. The apparatus includes at least one processor; and at least one memory storing instructions that, when executed by the at least one processor, cause the apparatus at least to: receive, from a radio assess network (RAN), device, an event associated with at least one quality of service (QoS) flow of a specific traffic type, wherein the at least one QoS flow is associated with a flow coordination group identity; and perform a coordination for the at least one QoS flow based at least on the event.

In a second aspect, there is provided an apparatus. The apparatus includes at least one processor; and at least one memory storing instructions that, when executed by the at least one processor, cause the apparatus at least to transmit, to a RAN controller, an event associated with at least one QoS flow of a specific traffic type, wherein the at least one QoS flow is associated with a flow coordination group identity.

In a third aspect, there is provide a method. The method comprises receiving, from a RAN device and to a RAN controller, an event associated with at least one QoS flow of a specific traffic type, wherein the at least one QoS flow is associated with a flow coordination group identity; and performing a coordination for the at least one QoS flow based at least on the event.

In a fourth aspect, there is provide a method. The method comprises transmitting, from a RAN device and to a RAN controller, an event associated with at least one QoS flow of a specific traffic type, wherein the at least one QoS flow is associated with a flow coordination group identity.

In a fifth aspect, there is provided an apparatus comprising means for receiving, from a RAN device, an event associated with at least one QoS flow of a specific traffic type, wherein the at least one QoS flow is associated with a flow coordination group identity; and means for performing a coordination for the at least one QoS flow based at least on the event.

In a sixth aspect, there is provided an apparatus comprising means for transmitting, to a RAN controller, an event associated with at least one QoS flow of a specific traffic type, wherein the at least one QoS flow is associated with a flow coordination group identity.

In a seventh aspect, there is provided a computer readable medium having a computer program stored thereon which, when executed by at least one processor of a device, causes the device to carry out the method according to the third aspect or the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example environment in which example embodiments of the present disclosure may be implemented;

FIG. 2 shows a signaling chart illustrating a process of coordination for round-trip communications according to some example embodiments of the present disclosure;

FIG. 3 shows a signaling chart illustrating a process of coordination for round-trip communications according to some example embodiments of the present disclosure;

FIG. 4 shows a flowchart of an example method of coordination for round-trip communications according to some example embodiments of the present disclosure;

FIG. 5 shows a flowchart of an example method of coordination for round-trip communications according to some example embodiments of the present disclosure;

FIG. 6 shows a simplified block diagram of a device that is suitable for implementing example embodiments of the present disclosure; and

FIG. 7 shows a block diagram of an example computer readable medium in accordance with some embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture includes a Centralized Unit (CU) and a Distributed Unit (DU) at an IAB donor node. An IAB node includes a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

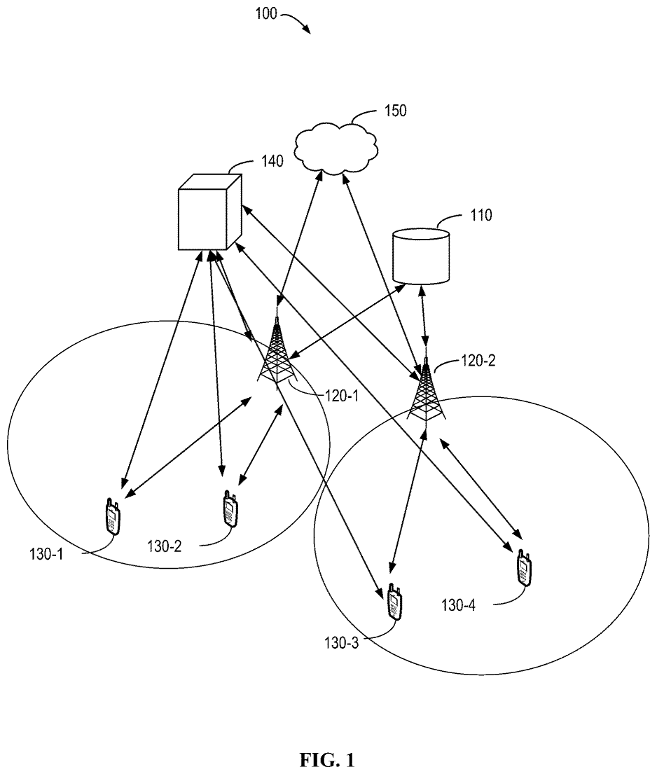

FIG. 1 shows an example communication network 100 in which embodiments of the present disclosure may be implemented. As shown in FIG. 1, the communication network 100 may include a RAN controller 110, which may also be referred to as a RAN Intelligent Controller (RIC) or a near real time (RT) RIC.

The communication network 100 may further include RAN devices 120-1 and 120-2. Hereinafter each of the RAN devices 120-1 and 120-2 may also be referred to as a gNB and the RAN devices 120-1 and 120-2 may also be referred to as a RAN device 120 collectively. The RAN devices 120-1 and 120-2 may communicate with the RAN controller 110 respectively.

In some scenarios, the RAN controller 110 may also be considered as a function integrated in the RAN devices 120-1 and 120-2. For example, the RAN controller 110 may be considered as a function enhancement of one or more logical CU-Control Plane (CP).

The communication network 100 may further include terminal devices 130-1, 130-2, 130-3 and 130-4. Hereinafter each of terminal devices 130-1, 130-2, 130-3 and 130-4 may also be referred to as a UE and the terminal devices 130-1, 130-2, 130-3 and 130-4 may also be referred to as a terminal device 130 collectively.

As an example, the terminal devices 130-1 and 130-2 may communicate with the RAN device 120-1 within a coverage of the RAN device 120-1 and the terminal devices 130-3 and 130-4 may communicate with the RAN device 120-1 within a coverage of the RAN device 120-2, respectively.

Furthermore, the communication network 100 may further include a core network (CN) device 140 and a server 150. For example, the server 150 may be a XRM server.

It is to be understood that the number of network devices and terminal devices shown in FIG. 1 is given for the purpose of illustration without suggesting any limitations. The communication network 100 may include any suitable number of network devices and terminal devices.

In some example embodiments, links from the RAN device 120 to the terminal device 130 may be referred to as a downlink (DL), while links from the terminal device 130 to the RAN device 120 may be referred to as an uplink (UL). In DL, the RAN device 120 is a transmitting (TX) device (or a transmitter) and the terminal device 130 is a receiving (RX) device (or receiver). In UL, the terminal device 130 is a TX device (or transmitter) and the RAN device 120 is a RX device (or a receiver).

Communications in the communication environment 100 may be implemented according to any proper communication protocol(s), includes, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, includes but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As mobile media services, cloud AR/VR, cloud gaming, video-based tele-control for machines or drones being expected to contribute more and more traffics to 5G network, a study of investigate enhancements of quality of service (QoS) mechanisms considering the characteristics of XRM and other media services is to be discussed. This study item aims at identifying the system architecture aspects related to better support advanced media services, e.g., Ultra Reliable Low Latency Communication (URLLC) services, AR/VR/XRM services, interactive media services and tactile/multi-modality communication services.

There are different types of traffic that may be present in UL for different XRM applications. As an example of UL XRM traffic for a UE, pose/control traffic is periodic (4 ms) with fixed size, video traffic may be 60/90/120 fps with variable frame size, and audio traffic is periodic (20 ms).

For the study of investigate enhancements of QoS mechanisms considering the characteristics of XRM, several key issues are defined. First, a single or multiple UEs are assumed to deliver related tactile and multi-modal data (e.g., audio, video and haptic data related to a specific time) with an application to the user at a similar time. The study for tactile and multi-modal support may focus on the set of UEs and data flows, the expected QoS handling and associated triggering events, other coordination information for the transmission of multiple UEs' flows (e.g., haptic, audio and video) of a multi-modal communication session. The coordination information (e.g., flow grouping information and necessity) can even be provided from 5GC to RAN to do optimization actions for group admission control and QoS fulfilment.

Second, to provide immersive experience for users, the XRM with real-time interaction typically require very low RT latency. During the RT transmission for XRM traffic, the challenge is how to meet the very low RT latency requirement with the variable and unbalanced uplink/downlink latency overhead.

In some scenario for the RAN structure, Radio Intelligent Controller (RIC) may be considered as a new virtualized function which adds RAN programmability to existing or new RAN networks i.e., Self-organizing Networks (SON) type functions, and provide following functions, namely RAN optimization and automation from Artificial Intelligence (AI)/Machine learning (ML), fast closed loop to deliver real-time SON benefits, leveraging AI/ML cloud capabilities, supporting LTE and 5G, classical RAN and vRAN and Open Application Programming Interface (API) towards 3rd party Applications (xApp) which need to be integrated with the RAN.

A near Real Time (RT) RIC may connect 100-1000 gNBs/DUs, thus potentially play a role to centralized coordination the radio resource of the gNBs. The near RT RIC may connect with gNB/Virtual CU (vCU) plus Virtual DU (vDU) via E2 interface, which support near real time (10-100 ms) data exchange between RIC and gNB, thus 10-100 ms level RAN data collection and RRC control policy input can be realized by near RT RIC. The near RT RIC may provide enhance function for CU-CP via xAPP, E2 interface and AI/ML capability.

The near RT RIC may be defined as a RAN network function connected to one or more “E2 Nodes” (i.e., 3GPP defined RAN network functions extended to support the O-RAN defined E2 interface). As described above, from 3GPP architecture point of view, the near RT RIC may be considered as a function enhancement of one or more logical CU-CP.

In some typical XRM service scenarios, the system consists of a XRM server capable of serving several online XRM clients. Each XRM client UE receives a stream of the live DL traffic from the XRM server and sends UL traffic back to the server that influence the content of the DL traffic. UL traffic may include handheld controller inputs, biometric readings, 6DOF+ motion, haptic, audio and video (shooting the user itself). In an extension, more than one XRM clients of e.g., Cloud Gaming, may be co-located at a session using centralized (via XRM server) communication to enhance the user experience due to improved QoS parameters.

For video traffic, no matter UL or DL, frame encoding may introduce variable delay due to different size of the I/P-frame within the Group of Pictures (GoP). Generally, a P-frame is encoded based on the I-frame in one GoP and the last received uplink pose frame. The size of P-frame is based on the view difference to the I-frame and typically, the size of the P-frame varies between 20% and 50% of the size of I-frame. On the one side, the UE application layer generates the packets with different encoding delay. On the other side, the mainstream view considers XRM devices are connected to a (gateway) UE, i.e., 5G terminal device, for example smart phone, via short distance communication methods. The different short distance wireless interface between the different XRM devices and the (gateway) UE may cause different transmission delays.

With this delay differences between different XRM devices, the network may have to face challenges of communication performance and QoS experience. First, the delay from UL may be accumulated to the DL. Considering the worst case, the DL transmission must wait until the packet from the last received UL client. The situation is worse when different XRM clients under control of different gNBs.

For example, as shown in FIG. 1, in case where a first and a second UL traffic flows from terminal device 130-1 and 130-2 to the RAN device 120-1 and a third and a fourth UL traffic flows from the terminal device 130-3 and 130-4 to the RAN device 120-2 are associated with a same XRM traffic flow group, if the first UL traffic flow and the fourth UL traffic flow have a larger transmission delay, the corresponding DL transmissions associated with the second and the third UL traffic flows may need to wait.

Second, UE's transmission behaviors are not coordinated. If no optimization is performed for the packet from the last received client, the RT delay budget may not be always met. In that case to meet the RT delay budget, late arrived UL packet, which consume too much of the RT delay budge may result in its associated DL packet be dropped in the 5GS (at the user plane function (UPF) or gNB).

According to some example embodiments of the present disclosure, there is provided a solution for coordination for round-trip communications. In the solution, the RAN device 120 transmits to the RAN controller 110 an event associated with at least one QoS flow of a specific traffic type, wherein the at least one QoS flow is associated with a flow coordination group identity and statistic information of at least one QoS flow of the specific traffic type associated with a same flow coordination group identity. The RAN controller 110 performs a coordination for the at least one QoS flow based at least on the event.

In this way, with the coordination processing, the time distribution of all the UL/DL traffic from different XRM clients can be controlled to leave the RAN side within a reasonable time period and therefore reduce the delay differences and reduce the traffic data dropping probability.

Example embodiments of the present disclosure will be described in detail below with reference to the accompanying drawings.

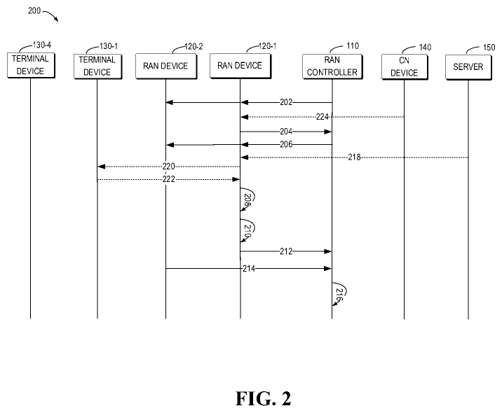

Reference is now made to FIG. 2, which shows a signaling chart 200 for communication according to some example embodiments of the present disclosure. As shown in FIG. 2, the signaling chart 200 involves a terminal device 130-1, a terminal device 130-4, a RAN device 120-1, a RAN device 120-2, a RAN controller 110, a CN device 140 and a server 150. For the purpose of discussion, reference is made to FIG. 1 to describe the signaling chart 200. Although FIG. 2 mainly focus on the interactions between the RAN device 120-1 and the RAN controller 110, it would be appreciated that other RAN device(s) (for example, the RAN device 120-2) may also perform similar operations as described with respect to the RAN device 120-1 below.

In the scenario of FIG. 2, the terminal device 130-1 may be served by the RAN device 120-1 and the terminal device 130-4 may be served by the RAN device 120-2. It is to be understood that the RAN device 120-1 and the RAN device 120-2 may also serve other terminal device(s). The RAN devices 120-1 and 120-2 may be controlled by the RAN controller 110. It is also possible that the RAN controller 110 may be a function integrated in each of RAN devices 120-1 and 120-2.

In the scenario of FIG. 2, the terminal devices 130-1 and 130-4 may act as XRM clients, which had established Protocol Data Unit (PDU) session with 5GS. As shown in FIG. 2, the RAN controller may transmit (202) a request, e.g., a RIC Subscription containing a Report service, to the RAN device 120-1 (and/or RAN device 120-2) for subscribing an event associated with at least one QoS flow of a specific traffic type. For example, the specific traffic type may be the XRM traffic. The subscribed event may be an event associated with XRM QoS flow. It is also possible that the specific traffic type may include any other traffic type which requires a low latency.

The at least one QoS flow belongs to a same QoS flow coordination group ID. The coordination group ID used hereinafter may also be referred to as a multi-modal service ID.

Further, the CN device 140 transmit assistance information of XRM QoS flow to the RAN device 120-1. In some embodiments, the CN device 140 may receive service requirements, alternative service requirements for Guaranteed Bit Rate (GBR) traffic, a multi-modal service ID, multi-modal service requirements (e.g., QoS monitoring for multiple IP data flows associated to a multi-modal application). The multi-modal service ID may indicate that multi-terminal devices (UEs)/flows are correlated to each other. In some embodiments, the RAN device 120-1 may receive (224), from the CN device 140, QoS flow coordination group ID, QoS profile, alternative QoS Profiles (including association relationship information with alternative QoS Profiles of other QoS flows in the group) and group level treatment policy per terminal device using the existing single PDU session modification procedure.

Upon receiving the assistance information of XRM QoS flow, the RAN device 120-1 may decide whether the relevant terminal device (for example, the terminal device 130-1) is subject to XRM monitoring based on received subscription from the RAN controller 110. If the RAN device 120-1 detects a XRM QoS flow establishment or modification event associated with the terminal device 130-1, the RAN device 120-1 may report (204) the detected XRM QoS flow establishment or modification event to RAN controller 110. In some embodiments, both received assistance information and QoS information may be included in the report.

After receiving the report of the XRM QoS flow establishment or modification event, the RAN controller 110 may subscribe or re-subscribe further event of XRM traffic pattern to the RAN device 120-1. For example, the RAN controller 110 may transmit (206) a further request, e.g., a RIC Subscription containing a Report service to the RAN device 120-1 (and/or RAN device 120-2) for subscribing further event of XRM traffic pattern.

Based on the request to subscribing a further event of XRM traffic pattern, the RAN device 120-1 may detect multi-modal service flows include both DL and UL traffic and log (208) the corresponding reception time or transmit time associated with the DL and UL traffic. Specifically, the RAN device 120-1 may log the reception time of each received DL packet and then log the reception time of each received correlated UL packet.

For example, when the RAN device 120-1 receives (218) DL traffic data from the server 150. The RAN device 120-1 may log arrive time per packet. When the RAN device 120-1 transmits (220) the DL traffic data to the terminal device 130-1, the RAN device 120-1 may also log DL transmit time per packet. When the RAN device 120-1 receives (222) UL traffic data from the terminal device 130-1, the RAN device 120-1 may log the UL reception time per packet.

Based on the logged reception time and/or transmit time, the RAN device 120-1 may derive (210) the statistic information of the XRM packet of the at least one QoS flow of the specific traffic type and stores results. In some embodiments, the statistic information of XRM packet delivery may include at least one of delay information, delay variation information, periodicity information or periodicity variation information and drop probability of the at least one QoS flow of the specific traffic type and delay differences between the at least two QoS flows in the at least one QoS flow of the specific traffic type. The at least two QoS flows may belong to a same terminal device or different terminal devices, for example, two QoS flows between the terminal device 130-1 and the network device 120-1, or a QoS flow between the terminal device 130-1 and the network device 120-1 and the terminal device 130-2 (not shown in FIG. 2) and the network device 120-1, respectively. Then the RAN device 120-1 report (212), to the RAN controller 110, the statistic information associated with XRM packet delivery of the at least one QoS flow associated with the terminal device 130-1.

Similar operations may also be performed between the RAN controller 110 and the RAN device 120-2. Thus, the RAN device 120-2 may also report (214), to the RAN controller 110, the statistic information associated with XRM packet delivery for the terminal device 130-4. The at least one XRM QoS flow associated with the terminal device 130-1 and the at least one XRM QoS flow associated with the terminal device 130-4 are relevant to the same QoS flow coordination group ID. In this way, the RAN controller 110 may collect (216) statistic information associated with XRM packet delivery of all XRM QoS flows belonging to the same QoS flow coordination group ID served by one or more RAN devices (120-1, 120-2).

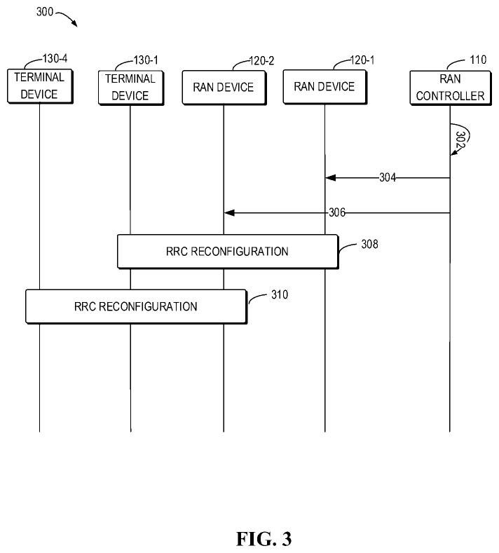

Reference is now made to FIG. 3, which shows a signaling chart 300 for communication according to some example embodiments of the present disclosure. As shown in FIG. 3, the signaling chart 300 involves a terminal device 130-1, a terminal device 130-4, a RAN device 120-1, a RAN device 120-2 and a RAN controller 110. For the purpose of discussion, reference is made to FIG. 1 to describe the signaling chart 300.

Based on the received statistic information from the RAN device 120-1 and RAN device 120-2, which has been described with reference to FIG. 2, the RAN controller 110 may determine (302) the transmission delay between the XRM QoS flow associated with the terminal device 130-1 and the XRM QoS flow associated with the terminal device 130-4. It is to be understood that the RAN controller 110 may also obtain statistic information of other XRM QoS flow(s), for example, associated with the terminal device 130-2 and/or the terminal device 130-3. The other XRM QoS flow(s) may belong to the same QoS flow coordination group ID with the XRM QoS flow associated with the terminal device 130-1 and the XRM QoS flow associated with the terminal device 130-4.

For example, if the RAN controller 110 detects that UL traffic of terminal device 130-4 always has the longest delay and UL traffic of terminal device 130-1 always has the shortest delay. Such delay difference may make the DL PDB too tight. The RAN controller 110 may determine to coordinate XRM client's behaviour by reducing the delay budget for the terminal device 130-4 and relaxing the delay budget for the terminal device 130-1.

For example, the RAN controller 110 may transmit (304, 306) a resource allocation instruction to the RAN device 120-1 and RAN device 120-2, respectively, to optimize the resource reservation for both transmissions of the QoS flows associated with the terminal device 130-1 and the terminal device 130-4.

In some embodiments, the resource allocation instruction transmitted from the RAN controller 110 e.g., a RIC Control procedure may be used for optimizing the ongoing sessions, i.e., current transmissions of the QoS flows associated with the terminal device 130-1 and the terminal device 130-4.

Additionally or optionally, the resource allocation instruction transmitted from the RAN controller 110 e.g., a RIC Subscription message containing a Policy service, may be used for optimizing the future sessions. That is, the resource allocation instruction may be used as traffic pattern for the further transmissions associated with the corresponding terminal devices.

For example, the resource allocation pattern for the subsequent transmission may be indicated by the RAN device 120-1 to the terminal device 130-1 via a RRC reconfiguration 308 and indicated by the RAN device 120-2 to the terminal device 130-4 via a RRC reconfiguration 310.

In some embodiments, the RAN controller 110 may determine the resource allocation instruction or the future traffic pattern by using an AL/ML model at the RAN controller 110. The AL/ML model may be trained based on history collected status of the RAN devices and instant RAN performance information, to predict the traffic load among neighbour RAN devices, evaluate inter-cell interference and monitor system performance of different frequency bandwidth parts.

As described above, the present disclosure proposes a solution for a RAN controller to monitor and learn traffic pattern for all UL/DL relevant QoS flows belonging to the same flow group of an XRM multi-modal service, which are under the control of one or more RAN devices controlled by the RAN controller and derive the worst case of delay differences between QoS flows belonging to the same flow group of an XRM multi-modal service in one communication direction. Furthermore, based on the solution of the present disclosure, the RAN controller may coordinate behaviours of part of or all XRM clients belonging to the same XRM multi-modal service by coordination calculations among one or more network devices controlled by the network controller that control the QoS flows belonging to the same flow group, and update the resource scheduling method to reduce the delay differences between different QoS flows.

In some embodiments, the solution of the present disclosure makes use of E2 interface and a centralized coordination and optional AI inference capability of the intelligent capability of RAN Intelligent Controller (e.g., RIC) to derive traffic pattern of one communication direction and trigger scheduling optimization in the other communication direction.

In the solution of the present disclosure, the RAN controller may have ability to subscribe XRM related one or more event(s) associated with at least one QoS flow of a specific traffic type, including at least one of QoS flow establishment or modification event. At least one of the following along with the event, including flow grouping information, indicating which group of QoS flows are belonging to the same multi-modal service; necessity/importance information, i.e., an application may prioritize one or more traffic flows than other; QoS parameters, e.g., RT delay budget, TSC Assistance Container (TSCAI) such as periodicity and burst arrival time and/or traffic volume information, e.g., maximum burst size, Maximum Data Burst Volume (MDBV), or Buffer Status Report (BSR) information. Furthermore, the RAN controller may learn traffic pattern for all UL/DL relevant QoS flows belonging to the same flow group of an XRM multi-modal service and detect behaviour differences between different XRM clients based on received event report from subscribed RAN devices. In some embodiments, the RAN controller may detect those one or more flows arrive RAN device too early or too late than others or those one or more flows cannot meet the RT delay. Such monitoring can be performed within a pre-defined/configured time window.

Based on the detection, the RAN controller may also coordinate resource scheduling of part of or all detected flows to reduce the delay differences between monitored QoS flows. For example, the RAN controller may perform coordination calculations among all RAN devices controlling the detected QoS flows and update the resource scheduling instruction to the RAN devices based on necessity/importance information of the detect one or more flows. The RAN controller may also instruct RAN devices to allocate extra resource to at least one QoS flow arrived too late and reduce the delay budget or instruct RAN devices to relax the scheduling budget of at least one QoS flow arrived too early and reduce the delay differences of different QoS flows from different XRM clients.

In some embodiments, the RAN controller may derive the radio resource scheduling instruction by using AI/ML model. The AI/ML model may use the collected RAN device status and instant RAN performance information to predict the traffic load among neighbour RAN devices, evaluate inter-cell interference and monitor system performance of different frequency bandwidth parts.

From RAN device's perspective, the RAN device may have ability to report XRM related events to subscribed RAN controller, receive resource scheduling instruction from the RAN controller and update radio resources accordingly. In some embodiments, the RAN device may also report XRM related CP event to the RAN controller if the RAN device receives flow grouping information, necessity/importance information, QoS parameters from the CN device. Furthermore, the RAN device may monitor the arrival of each burst, derive the burst size and the burst arrival time and report XRM related User Plane (UP) event to the RAN controller.

In some embodiments, the RAN device may also use the policies from the Near-RT RIC to optimize the outcome. For example, if the RAN controller transmits, to the RAN device, a resource scheduling instruction for coordinating future transmissions, the RAN device may adjust the scheduling instruction based on instant radio environment to optimize the system performance.

In some embodiments, the operations of the RAN controller may also be performed by the RAN device if the RAN controller is deployed within the RAN device or is not deployed and/or E2 interface or appropriate E2 Service Model (E2SM) is not support on the RAN device. For example, the RAN device handles the NGAP and RRC signaling, learns the traffic pattern, calculates the worst-case delay differences and coordinate the scheduling locally within the RRM control plane.

In some embodiments, the group of terminal devices in the same XRM experience may be split into multiple subgroups (i.e., each subgroup is all terminal devices under the same RAN controller) and then the solution optimizes UL and DL times for each subgroup based on the solution of the present disclosure.

In some embodiments, one RAN controller may determine the coordination strategies based on inputs from one or more neighbouring RAN controllers.

In this way, it can treat coordination for multiple QoS flows belonging to the same flow group and controlled by the different RAN devices because the RAN controller has all relevant RAN nodes information. Together with computing power of state-to-art algorithms, include machine learning algorithms, the RAN controller can be the single representative of all ongoing traffics. Therefore, the solution of the present disclosure can derive more efficient and effective resource scheduling for XRM to guarantee the QoS fulfilment.

In additional, based on the solution of the present disclosure, it is feasible to utilize the derived BAT preference to adapt application transmission scheduling according to the deterministic transmission capability of the 5GS.

With the coordination processing, the time distribution of all the UL/DL traffic from different XRM clients can be controlled to leave the RAN side within a reasonable time period and therefore reduce the accumulated jitter and reduce the traffic data dropping probability.

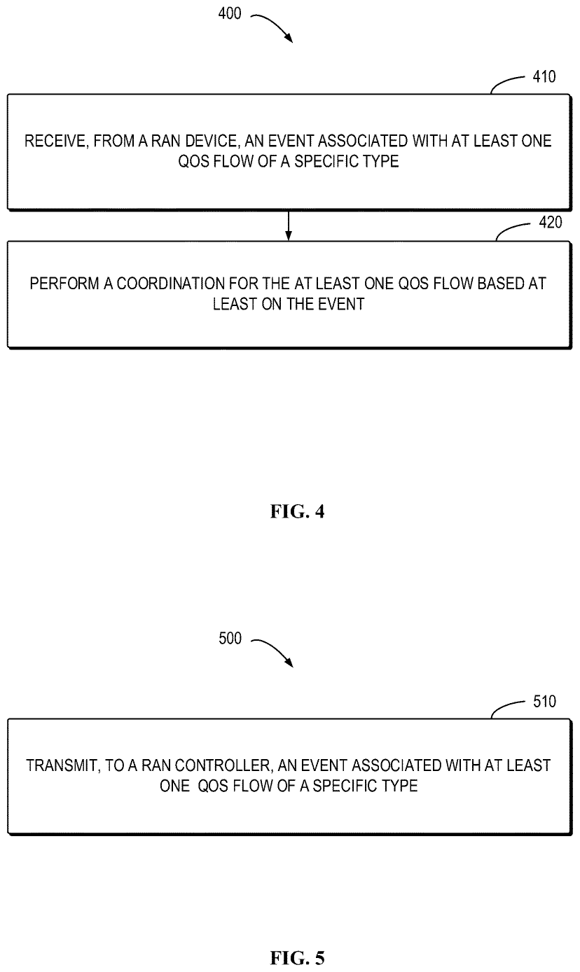

FIG. 4 shows a flowchart of an example method 400 for the coordination for round-trip communications according to some example embodiments of the present disclosure. The method 400 may be implemented at the RAN controller 110 as shown in FIG. 1. For the purpose of discussion, the method 400 will be described with reference to FIG. 1.

At 410, the RAN controller 110 receives, from a RAN device, an event associated with at least one QoS flow of a specific traffic type, wherein the at least one QoS flow is associated with a flow coordination group identity.

At 420, the RAN controller 110 performs a coordination for the at least one QoS flow based at least on the event.

In some example embodiments, the RAN controller 110 may transmit, to the RAN device, a request of subscribing the event of the at least one QoS flow.

In some example embodiments, the event subscribed by the apparatus comprises at least one of: an establishment of the at least one QoS flow of the specific type, a modification of the at least one QoS flow of the specific type or a traffic pattern of the at least one QoS flow of the specific type.

In some example embodiments, the RAN controller 110 may receive, from the RAN device, at least one of the following along with the event: flow group information of at least one QoS flow; priority information of the at least one QoS flow; importance information of the at least one QoS flow; one or more parameters associated with QoS; time sensitive communications assistance information of the at least one QoS flow; or traffic volume information of the at least one QoS flow.

In some example embodiments, the RAN controller 110 may receive, from the RAN device, statistic information of the at least one QoS flow.

In some example embodiments, the statistic information comprises at least one of: delay information of the at least one QoS flow; delay variation information of the at least one QoS flow; periodicity information of the at least one QoS flow; periodicity variation information of the at least one QoS flow; drop probability of the at least one terminal device; or delay difference between two QoS flows in the at least one QoS flow.

In some example embodiments, if the RAN controller determines, based on at least one of the event or the statistic information, that a delay difference between a QoS flow in the at least one QoS flow and a further QoS flow in the at least one QoS flow associated with the same flow coordination group identity satisfy a threshold level, the RAN controller 110 may coordinate the QoS flow and the further QoS flow by adjusting the delay difference.

In some example embodiments, the RAN controller 110 may transmit, to the RAN device, a resource scheduling instruction for coordinating ongoing transmissions or future transmissions of the at least one QoS flow.

In some example embodiments, the RAN controller 110 may transmit, to the RAN device, a traffic pattern for the at least one QoS flow in a communication direction, for a scheduling optimization of the at least one QoS flow in a further communication direction.

In some example embodiments, the RAN controller 110 may train a machine learning model based on history statistic information of at least one previous QoS flow between the RAN device and the at least one terminal device; and perform the coordination for the at least one QoS flow by using the trained machine learning model based on at least one of the event, or the statistic information.

FIG. 5 shows a flowchart of an example method 500 of the coordination for round-trip communications according to some example embodiments of the present disclosure. The method 500 may be implemented at the network device 120 shown in FIG. 1. For the purpose of discussion, the method 500 will be described with reference to FIG. 1.

At 510, the network device 120 transmits, to a RAN controller, an event associated with at least one QoS flow of a specific traffic type, wherein the at least one QoS flow is associated with a flow coordination group identity.

In some example embodiments, the network device 120 may receive, from the RAN controller, a request of subscribing the event of the at least one QoS flow.

In some example embodiments, the event subscribed by the apparatus comprises at least one of: an establishment of the at least one QoS flow of the specific type, or a traffic pattern of the at least one QoS flow of the specific type.

In some example embodiments, the RAN device may transmit, to the RAN controller, at least one of the following along with the event: flow group information of at least one QoS flow; priority information of the at least one QoS flow; importance information of the at least one QoS flow; one or more parameters associated with QoS; time sensitive communications assistance information of the at least one QoS flow; or traffic volume information of the at least one QoS flow.

In some example embodiments, the RAN device may transmit, to the RAN controller, statistic information of the at least one QoS flow.

In some example embodiments, the statistic information comprises at least one of: delay information of the at least one QoS flow; delay variation information of the at least one QoS flow; periodicity information of the at least one QoS flow; periodicity variation information of the at least one QoS flow; drop probability of the at least one terminal device; or delay difference between two QoS flows in the at least one QoS flow.

In some example embodiments, the RAN device 120 may log respective uplink reception time and downlink reception time of the at least one QoS flow of the specific traffic type; and generate the statistic information at least based on the respective uplink reception time and downlink reception time.

In some example embodiments, the RAN device 120 may receive, from the RAN controller, a resource scheduling instruction for coordinating ongoing transmissions or future transmissions of the at least one QoS flow.

In some example embodiments, the RAN device 120 may receive. from the RAN controller, a traffic pattern for the at least one QoS flow in a communication direction; and optimize a scheduling of the at least one QoS flow in a further communication direction based on the traffic pattern.

In some example embodiments, an apparatus capable of performing the method 400 (for example, implemented at the RAN controller 110) may include means for performing the respective steps of the method 400. The means may be implemented in any suitable form. For example, the means may be implemented in a circuitry or software module.

In some example embodiments, the apparatus comprises means for receiving, from a RAN device, an event associated with at least one QoS flow of a specific traffic type, wherein the at least one QoS flow is associated with a flow coordination group identity; and means for performing a coordination for the at least one QoS flow based at least on the event.

In some example embodiments, the apparatus further comprises means for transmitting, to the RAN device, a request of subscribing the event of the at least one QoS flow.

In some example embodiments, the event subscribed by the apparatus comprises at least one of: an establishment of the at least one QoS flow of the specific type, or a traffic pattern of the at least one QoS flow of the specific type.

In some example embodiments, the apparatus further comprises means for receiving, from the RAN device, at least one of the following along with the event: flow group information of at least one QoS flow; priority information of the at least one QoS flow; importance information of the at least one QoS flow; one or more parameters associated with QoS; time sensitive communications assistance information of the at least one QoS flow; or traffic volume information of the at least one QoS flow.

In some example embodiments, the apparatus further comprises means for receiving, statistic information of the at least one QoS flow.

In some example embodiments, the statistic information comprises at least one of: delay information of the at least one QoS flow; delay variation information of the at least one QoS flow; periodicity information of the at least one QoS flow; periodicity variation information of the at least one QoS flow; drop probability of the at least one terminal device; or delay difference between two QoS flows in the at least one QoS flow.

In some example embodiments, the apparatus further comprises means for, in accordance with a determination, based on at least one of the event or the statistic information, that a delay difference between a QoS flow in the at least one QoS flow and a further QoS flow in the at least one QoS flow associated with the same flow coordination group identity satisfy a threshold level, coordinating the QoS flow and the further QoS flow by adjusting the delay difference.

In some example embodiments, the apparatus further comprises means for transmitting, to the RAN device, a resource scheduling instruction for coordinating ongoing transmissions or future transmissions of the at least one QoS flow.

In some example embodiments, the apparatus further comprises means for training a machine learning model based on history statistic information of at least one previous QoS flow between the RAN device and the at least one terminal device; and performing the coordination for the at least one QoS flow by using the trained machine learning model based on at least one of the event, or the statistic information.

In some example embodiments, an apparatus capable of performing the method 500 (for example, implemented at the RAN device 120) may include means for performing the respective steps of the method 500. The means may be implemented in any suitable form. For example, the means may be implemented in a circuitry or software module.

In some example embodiments, the apparatus comprises means for transmitting, to a RAN controller, an event associated with at least one QoS flow of a specific traffic type, wherein the at least one QoS flow is associated with a flow coordination group identity.

In some example embodiments, the apparatus further comprises means for receiving, from the RAN controller, a request of subscribing the event of the at least one QoS flow.

In some example embodiments, the event subscribed by the apparatus comprises at least one of: an establishment of the at least one QoS flow of the specific type, or a traffic pattern of the at least one QoS flow of the specific type.

In some example embodiments, the apparatus further comprises means for transmitting, to the RAN controller, at least one of the following along with the event: flow group information of at least one QoS flow; priority information of the at least one QoS flow; importance information of the at least one QoS flow; one or more parameters associated with QoS; time sensitive communications assistance information of the at least one QoS flow; or traffic volume information of the at least one QoS flow.

In some example embodiments, the apparatus further comprises means for transmitting, to the RAN controller, statistic information of the at least one QoS flow.

In some example embodiments, the statistic information comprises at least one of: delay information of the at least one QoS flow; delay variation information of the at least one QoS flow; periodicity information of the at least one QoS flow; periodicity variation information of the at least one QoS flow; drop probability of the at least one terminal device; or delay difference between two QoS flows in the at least one QoS flow.

In some example embodiments, the apparatus further comprises means for logging respective uplink reception time and downlink reception time of the at least one QoS flow of the specific traffic type; and means for generating the statistic information at least based on the respective uplink reception time and downlink reception time.

In some example embodiments, the apparatus further comprises means for receiving, from the RAN controller, a resource scheduling instruction for coordinating ongoing transmissions or future transmissions of the at least one QoS flow.

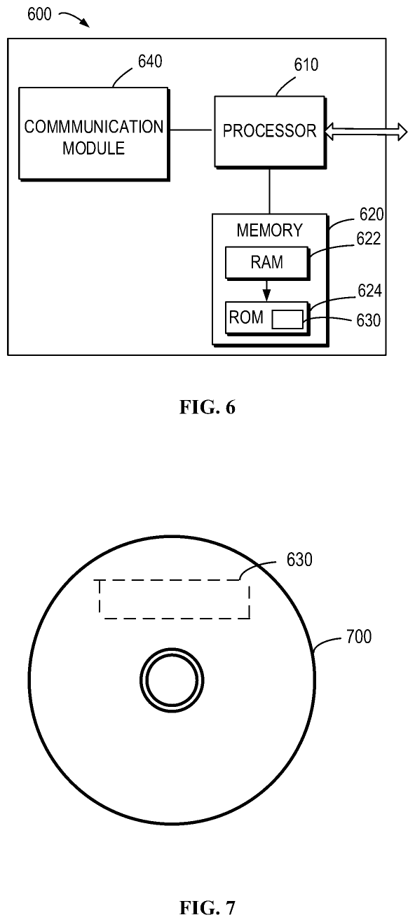

FIG. 6 is a simplified block diagram of a device 600 that is suitable for implementing example embodiments of the present disclosure. The device 600 may be provided to implement a communication device, for example, the RAN controller 110 or the RAN device 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 8. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. An apparatus comprising:
at least one processor; and
at least one memory storing instructions that, when executed by the at least one processor, cause the apparatus at least to:
receive, from a radio access network, RAN, device, an event associated with at least one quality of service, QoS, flow of a specific traffic type, wherein the at least one QoS flow is associated with a flow coordination group identity; and
perform a coordination for the at least one QoS flow based at least on the event.

2. The apparatus of claim 1, wherein the apparatus is caused to:
transmit, to the RAN device, a request of subscribing the event of the at least one QoS flow.

3. The apparatus of claim 2, wherein the event subscribed by the apparatus comprises at least one of:
an establishment of the at least one QoS flow of the specific traffic type,
a modification of the at least one QoS flow of the specific traffic type, or
a traffic pattern of the at least one QoS flow of the specific traffic type.

4. The apparatus of claim 1, wherein the apparatus is caused to:
receive, from the RAN device, at least one of the following along with the event:
flow group information of at least one QoS flow;
priority information of the at least one QoS flow;
importance information of the at least one QoS flow;
one or more parameters associated with QoS;
time sensitive communications assistance information of the at least one QoS flow; or
traffic volume information of the at least one QoS flow.

5. The apparatus of claim 1, wherein the apparatus is caused to:
receive, from the RAN device, statistic information of the at least one QoS flow.

6. The apparatus of claim 5, wherein the statistic information comprises at least one of:
delay information of the at least one QoS flow;
delay variation information of the at least one QoS flow;
periodicity information of the at least one QoS flow;
periodicity variation information of the at least one QoS flow;
drop probability of the at least one terminal device; or
delay difference between at least two QoS flows in the at least one QoS flow.

7. The apparatus of claim 4, wherein the apparatus is caused to:
in accordance with a determination, based on at least one of the event or the statistic information, that a delay difference between a QoS flow in the at least one QoS flow and a further QoS flow in the at least one QoS flow associated with the same flow coordination group identity satisfy a threshold level, coordinate the QoS flow and the further QoS flow by adjusting the delay difference.

8. The apparatus of claim 1, wherein the apparatus is caused to:
transmit, to the RAN device, a resource scheduling instruction for coordinating ongoing transmissions or future transmissions of the at least one QoS flow.

9. The apparatus of claim 1, wherein the apparatus is caused to:
transmit, to the RAN device, a traffic pattern for the at least one QoS flow in a communication direction, for a scheduling optimization of the at least one QoS flow in a further communication direction.

10. The apparatus of claim 4, wherein the apparatus is caused to:
train a machine learning model based on history statistic information of at least one previous QoS flow between the RAN device and the at least one terminal device; and
perform the coordination for the at least one QoS flow by using the trained machine learning model based on at least one of the event, or the statistic information.

11. An apparatus comprising:
at least one processor; and
at least one memory storing instructions that, when executed by the at least one processor, cause the apparatus at least to:
transmit, to a radio assess network, RAN, controller, an event associated with at least one quality of service, QoS, flow of a specific traffic type, wherein the at least one QoS flow is associated with a flow coordination group identity.

12. The apparatus of claim 11, wherein the apparatus is caused to:
receive, from the RAN controller, a request of subscribing the event of the at least one QoS flow.

13. The apparatus of claim 12, wherein the event subscribed by the apparatus comprises at least one of:
an establishment of the at least one QoS flow of the specific traffic type,
a modification of the at least one QoS flow of the specific traffic type, or
a traffic pattern of the at least one QoS flow of the specific traffic type.

14. The apparatus of claim 11, wherein the apparatus is caused to:
transmit, to the RAN controller, at least one of the following along with the event:
flow group information of at least one QoS flow;
priority information of the at least one QoS flow;
importance information of the at least one QoS flow;
one or more parameters associated with QoS;
time sensitive communications assistance information of the at least one QoS flow; or
traffic volume information of the at least one QoS flow.

15. The apparatus of claim 11, wherein the apparatus is caused to:
transmit, to the RAN controller, statistic information of the at least one QoS flow.

16. The apparatus of claim 15, wherein the statistic information comprises at least one of:
variation information of the at least one QoS flow;
periodicity information of the at least one QoS flow;
periodicity variation information of the at least one QoS flow;
drop probability of the at least one terminal device; or
delay difference between at least two QoS flows in the at least one QoS flow.

17. The apparatus of claim 11, wherein the apparatus is caused to:
log respective uplink reception time and downlink reception time of the at least one QoS flow of the specific traffic type; and
generate the statistic information at least based on the respective uplink reception time and downlink reception time.

18. The apparatus of claim 10, wherein the apparatus is caused to:
receive, from the RAN controller, a resource scheduling instruction for coordinating ongoing transmissions or future transmissions of the at least one QoS flow.

19. The apparatus of claim 10, wherein the apparatus is caused to:
receive. from the RAN controller, a traffic pattern for the at least one QoS flow in a communication direction; and
optimize a scheduling of the at least one QoS flow in a further communication direction based on the traffic pattern.

20. A method comprising:
receiving, by a radio assess network, RAN, controller and from a RAN device, at least one of an event or statistic information associated with at least one quality of service, QoS, flow of a specific traffic type, wherein the at least one QoS flow is associated with a flow coordination group identity; and
performing a coordination for the at least one QoS flow based at least on the event.

21-24. (canceled)
